(19) United States
(12) Patent Application Publication
(10) Pub. No.: US 2006/0136454 A1
(43) Pub. Date: Jun. 22, 2006

(54) Method for managing a hybrid distributed database in a communication network

(76) Inventors: Constant Wette Tchouati, Montreal (CA); Samuel Pierre, Laval (CA); Jean Conan, Montreal (CA)

Correspondence Address: ALEX NICOLAESCU;Ericsson Canada Inc., Patent Department, 8400 Decarie Blvd, Town Mount Royal, QC, H4P 2N2, CA

(21) Appl. No.: 11/245,122

(22) Filed: Oct. 7, 2005

Related U.S. Application Data
(60) Provisional application No. 60/636,119, filed on Dec. 16, 2004.

(51) Int. Cl. G06F 17/00

(52) U.S. Cl. 707/101

(57) ABSTRACT

A method and a hybrid distributed database for performing a transaction in a communication network. The distributed data base comprise a pessimistic scheduler for requesting a read/write lock from its associated transaction manager, determining if there is a conflict for the operation and for detecting a conflict of operation. If there is a conflict for the operation, the pessimistic scheduler requests a read/write lock for the transaction until obtaining the read/write lock and if not, the pessimistic scheduler obtains the read/write lock. The distributed database also comprises an optimistic scheduler for determining an operation type, determining if there is a conflict for the operation. If so, the optimistic scheduler determines an operation type until determining that the operation is not in conflict with an operation of another transaction. The pessimistic and optimistic schedulers each access an associated database node for performing the operation for the transaction.

### PRIORITY STATEMENT UNDER 35 U.S.C S.119(e) & 37 C.F.R. S.1.78

This non-provisional patent application claims priority based upon the prior U.S provisional patent application entitled “Hybrid concurrency control mechanism for partitioned distributed database system”, application No. 60/636,119, filed Dec. 16, 2004, in the names of Constant Wette Tchouati, Samuel Pierre and Jean Conan.

### BACKGROUND OF THE INVENTION

1. Field of the invention

The present invention relates to a method for operating a partitioned database in a communication network.

2. Description of the Related Art

A database is a collection of data recorded together for providing information to applications such as a multimedia, Internet Protocol Multimedia System (IMS) or Multimedia Messaging System (MMS). In a database, there is no dependency between data and applications. A database management system (DBMS) can be used to create databases and to add, query or modify data stored in such databases. The DBMS can be is a software, hardware or any combination thereof. A state of a database is characterized by values of its objects that represent some real objects. The state can be modified by the execution of a transaction.

A transaction is a reliable program that is made up of a sequence of read and write operations on the database. Its execution maps one consistent database state to another. The consistent state of a database is defined by a set of rules known as integrity constraints such as consistency and reliability. Consistency and reliability of a transaction are a consequence of the some fundamental properties such as the atomicity in which a system must complete all transaction's updates or none, the consistency is defined as the initial consistent state of a transaction and can be restored in case of failure, the isolation results of a transaction's updates is visible to other transactions before its commitment, in order to avoid the interferences and the durability once a transaction is treated, the DBMS must guarantee that its results are permanent and cannot be erased from the database.

A distributed database (DDB) is a set of databases stored on several distinct nodes that are connected within a same communication network. Reference is now made to FIG. 1, which represents a distributed database 11 in a communication network 10 in accordance to the prior art. A distributed database is managed by a distributed DBMS in which components are spread on various locations. A node is a combination of a TM, a SC, a DM and DB. In FIG. 1, the different nodes can be geographically distributed in separated locations. The nodes may alternatively be locally distributed in a clustered system and can appear to application as only one database 11. An application 15 may request information to the distributed database 11. The distributed database 11 comprises transaction managers (TMs) 12, scheduler (SCs) 14, data managers (DMs) 16 and database (DB) nodes 18. The TM 12 ensures the coordination of the execution of a transaction received from service applications. The SC 14 synchronizes operations of transactions in order to avoid inconsistencies. The SC 14 also runs one type of concurrency control algorithm, either a pessimistic algorithm or an optimistic algorithm. Each DMs 16 accesses a corresponding DB node 18, which stores data for users of a mobile equipment of a user registered in the communication network, for performing read or write operation on exiting data or may alternatively create the data if it do not already exist. The mobile equipment may be any mobile terminal (MT) in the communication network 10.

A distributed transaction is a transaction that access data on more than one database 18. A distributed transaction is subdivided by a receiving TM 12 into a number of operations. For example in FIG. 1, each TM 12 can execute a distributed transaction at different DB nodes 18. DBMSs must provide different types of transparencies: distribution and replication of data are transparent to services and applications 15. For example, the database 11 can be a set of DB nodes 18, each of them having one or more physical copies (replicas). Application 15 has a logical view of data. During an access, the DBMS is responsible for the translation of a read operation on a logical data into a read operation on only one physical copy, and for the translation of a write operation on a logical data into a write operation on any physical copies.

The distribution of the data on various locations is performed in order to minimize risks of failure and speed up local access. The distribution is done to maximize the gain on performance by partitioning the database. For performance, reliability, and availability reasons, replication is used for storing copies of one data entity on several DB nodes 18. In order to guarantee data consistency, update of replicas must be synchronized. However, but this may increase the average response time of the system.

A communication scenario between elements of the DBMS during the execution of a transaction when data are replicated now described. The TM 12 records a transaction submitted by application 15 with a Transaction identifier (TrId). Thus, for each transaction operation, the TM 12 contacts the SC 14 that controls accesses to the requested data in the database node 18. In case of a read operation, the SC 14 contacts only one of the nodes where a replica is stored. However in case of a write operation, each node with a replica is contacted. SCs 14 synchronize various accesses to data, and produce a global and serialisable schedule that preserves the consistent state of the distributed DB node after the commitment of all transactions in progress. To achieve this, the SC 14 can send operations directly to the DM 16 if there is no conflict, and delay or reject some operations in case of conflict. For a read operation, the DM 16 processes the access in the database and returns the value of the data; for a write operation the DM 16 modifies the value and returns an acknowledgment to the SC 14 who relays this information to the TM 12 who also transmits the result of the operation to the services and applications 15 that submitted the transaction.

There are basically two types of concurrency control algorithms: pessimistic and optimistic algorithms. In a distributed database, data are shared between the applications running on local and remote sites, and the algorithm must still satisfy the consistency constraint. When the concurrency degree increases, some transactions are either delayed in the case of the locking, or aborted in the case of the optimistic algorithm. This situation tends to increase the average response time and leads to degradation of performance. In order to minimize this, a trade-off solution, which consists of releasing some consistency constraints to achieve an acceptable level of performance may be applied.

A pessimistic algorithm solves transactions conflicts early in their execution phase based on syntactic information provided. This principle guarantees database consistency after the execution of transactions, but the average response time may become significant. An optimistic algorithm assumes that conflicts between transactions are not frequent and allows multiple accesses to the same data, until the validation phase. Unlike the pessimistic algorithm, the resolution of conflicts after execution takes into account the semantic information and therefore conflicting transactions are restarted.

An optimistic algorithm offers a better performance compared to a pessimistic algorithm when transactions conflicts are rare. However, in optimistic approach, many transactions are restarted when conflicts become frequent, and this rather leads to severe degradation of performance in comparison with a pessimistic algorithm. For this reason, a pessimistic algorithm is preferred in commercial DBMS. Then, the performance of scheduling algorithms depends on the type of applications requirements that can be satisfied, for example: minimum response time, high data availability, real time constraints, high throughput, guarantee of data consistency. The hardware characteristics may also have an impact on the efficiency of a scheduling algorithm.

The SC 14 may operate on a basis of a pessimistic locking algorithm. The pessimistic locking algorithm checks transactions conflicts early in their execution phase. The SC 14 may alternatively operate on a basis of an optimistic algorithm. The optimistic algorithm checks transaction conflicts after their execution phase. The pessimistic locking algorithm guarantees strong consistency, while the optimistic algorithm provides high availability, but none of them taken alone will satisfy all the requirements.

For DBMSs where both preservation of consistency and high performance are needed, hybrid algorithms using pessimistic algorithm and optimistic algorithm seem to offer the best compromise. For example when a DBMS is used for real-time applications such as charging applications where the preservation of consistency is more important than fastest response time, a pessimistic locking algorithm can be appropriate since there is less conflicts between transactions.

Data distribution and data replication concepts have introduced news constraints in the design of algorithms for distributed database management systems (DDBMS). Since some databases are partionned, replicated or diskless such as telecommunications databases, they require high performance and consistency. Therefore, it becomes necessary to provide high performance distributed algorithms to solve the consistency problem in distributed databases. The invention provides a solution to that problem.

### SUMMARY OF THE INVENTION

It is a broad object of the present invention to provide a method for performing an operation at a distributed database for at least one transaction sent from an application in a communication network, the method comprising the steps of:

receiving at a scheduler the operation related to the at least one transaction from a transaction manager;

if the scheduler is a pessimistic scheduler:
requesting at the pessimistic scheduler a read/write lock from its associated transaction manager;
determining at the pessimistic scheduler if there is a conflict for the operation:
   if there is a conflict for the operation, the pessimistic scheduler requests a read/write lock for the transaction until obtaining the read/write lock;
   if not, the pessimistic scheduler obtains the read/write lock;

if the scheduler is an optimistic scheduler:
determining at the optimistic scheduler an operation type;
determining at the optimistic scheduler if there is a conflict for the operation; and
   if there is a conflict the optimistic scheduler determines an operation type until determining that the operation is not in conflict with an operation of another transaction.

It is another broad object of the present invention to provide a distributed database for performing an operation at a distributed database for at least one transaction in a communication network, the distributed database comprising:

at least one pessimistic scheduler for requesting a read/write lock from its associated transaction manager, determining if there is a conflict for the operation, wherein if there is a conflict for the operation, the pessimistic scheduler requests a read/write lock for the transaction until obtaining the read/write lock and if not, the pessimistic scheduler obtains the read/write lock; and

at least one optimistic scheduler for determining an operation type, determining at the optimistic scheduler if there is a conflict for the operation, wherein if there is a conflict the optimistic scheduler determines an operation type until determining that the operation is not in conflict with an operation of another transaction.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 illustrates a distributed database that receives transactions from services and applications in a communication network in accordance to the to the prior art;

FIG. 2 illustrates a distributed database that receives transactions from services and applications in a communication network in accordance to the to the present invention; and

FIG. 3 depicts a flow chart of a method for managing the distributed database 21 in accordance to the invention.

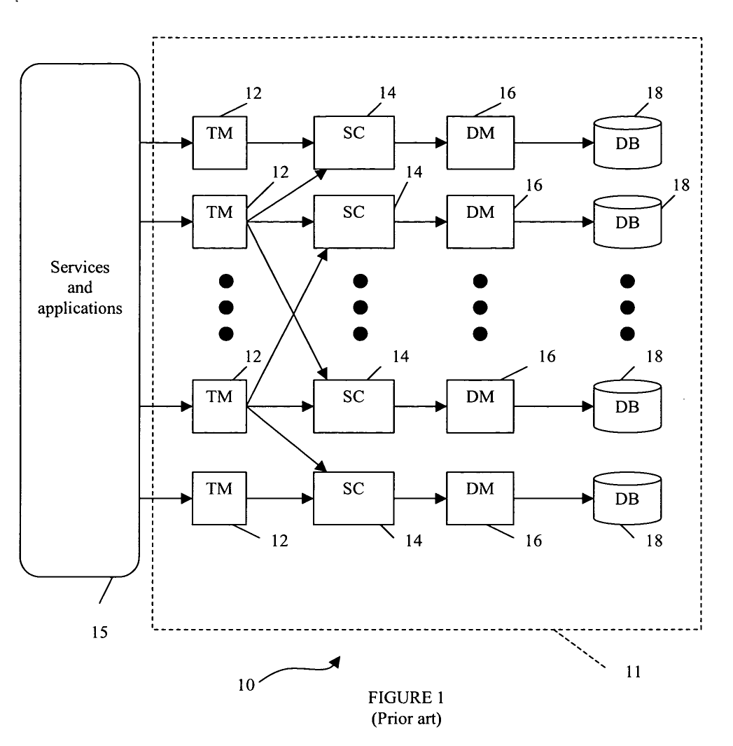

### DETAILED DESCRIPTION OF THE PREFERRED EMBODIMENTS

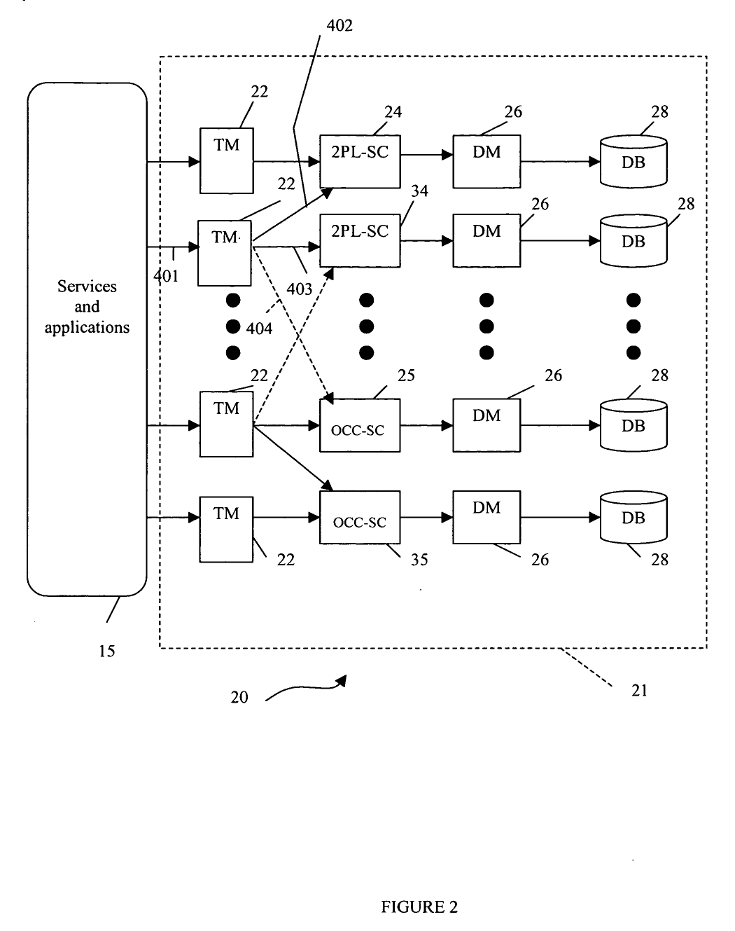

Reference is now made to FIG. 2, which illustrates a distributed database 21 that receives transactions from services and applications 15 in a communication network in accordance to the to the present invention. The services and applications 15 may be, while not being limited thereto, multimedia, IMS or MMS services applications.

The network 20 is preferably described as a generalized network in the present invention. The packet data network 20 may be any 2G network such as in a Time Division Multiple Access (TDMA) network or a Code Division Multiple Access (CDMA), 2.5G networks such as a General Packet Radio Service (GPRS) any 3G Universal Mobile Telecommunications Systems (3G UMTS) network such as a CDMA2000 network a Wideband Code Division Multiple Access (WCDMA) network, a Global System for Mobile Communications/Enhanced Data for GSM Evolution (GSM/EDGE) or a High Speed Packet Data Access (HSPDA) network.

For example, the distributed database 21 may be any types of distributed database that are used in mobile networks to store users' location data: the Home Location Register (HLR) and the Visitor Location Register (VLR) in a 2G network. The HLR is the main database of permanent subscriber information. Maintained by the subscriber's home carrier (or the network operator where the user initiates the call), the HLR contains pertinent user information, including addresses, account statuses, and preferences. The HLR interacts with the Mobile Switching Center (MSC), a switch used to control and process calls. The VLR, maintains temporary user information (such as current location) to manage requests from subscribers who are out of the area covered by their home system.

To establish a call between a user of a mobile equipment (not shown) and another mobile equipment or an application for receiving services, a TM 12 requests the location or the presence information of the called user, while another process would be updating the same information if it happens that the user is passing from one cell to another. When the user initiates the call, a switching equipment such as a Mobile Switching Center (MSC) (not shown) determines whether or not the call comes from within the device's home area. If the user is out of this home area, the VLR sends out the information request required to process the call. The MSC queries the HLR identified by the call for information, which it is relayed to the appropriate MSC, which is then relayed to the VLR. The VLR returns routing information to the MSC, thereby allowing it to find the station from whence the call originated and connect the mobile device.

In 3G networks the distributed database 21 may be a Home Subscriber Server (HSS) database for storing subscriber and service data like user identity, allocated Serving Call Session Control Function (S-CSCF), access parameters, registration information and service-triggering information presence. Alternatively, an Internet protocol Multimedia System (IMS) database may contain messaging, gaming, IP telephony, video conferencing and presence information.

The distributed database 21 is managed by a distributed database management system (DBMS). The distributed database 21 comprises similar elements that were previously described in the prior art. Namely the database 21 comprises transaction managers (TMs) 22, pessimistic scheduler (SCs) 24 and 34 optimistic scheduler 25 and 35, data managers (DMs) 26 and database (DB) nodes 18. The TM 12 ensures the coordination of the execution of a transaction received from service applications. The SC 14 synchronizes operations of transactions in order to avoid inconsistencies. The SC 14 also runs one type of concurrency control algorithm either a pessimistic or an optimistic algorithm. The DB nodes 28 may alternatively be locally distributed in a clustered system and can appear to applications 15 as only one database 21. The DMs 26 access the DB 28, which stores data for users of a registered mobile terminal in the communication network 20, for performing read or write operation on exiting data or may alternatively create the data if it do not already exist. DB nodes 28 of the distributed database 21 are equivalent. In particular, data can be created and stored on DB node 28. The same concurrency control mechanism is implemented on all schedulers. However, some data in DB nodes 28 are updated frequently and require pessimistic schedulers 24 and 34.

DB nodes 28 can be divided into two partitions and may select the suitable location at anytime to store each data type. A first partition containing DB nodes 28 associated with an optimistic SC and which can be used to store data with less updates and a second partition that contains DB nodes 28 associated with pessimistic SC and which implement the pessimistic part can be used to store data with high probability of conflicts. While optimistic SC 25 and 35 perform very well on some data with less updates type. It can be appreciated that TMs, SCs, DMs and DB nodes is not limited to the number shown in FIG. 2. Furthermore, the TMs, SCs, DMs and DB nodes can each be software, hardware or any combination thereof.

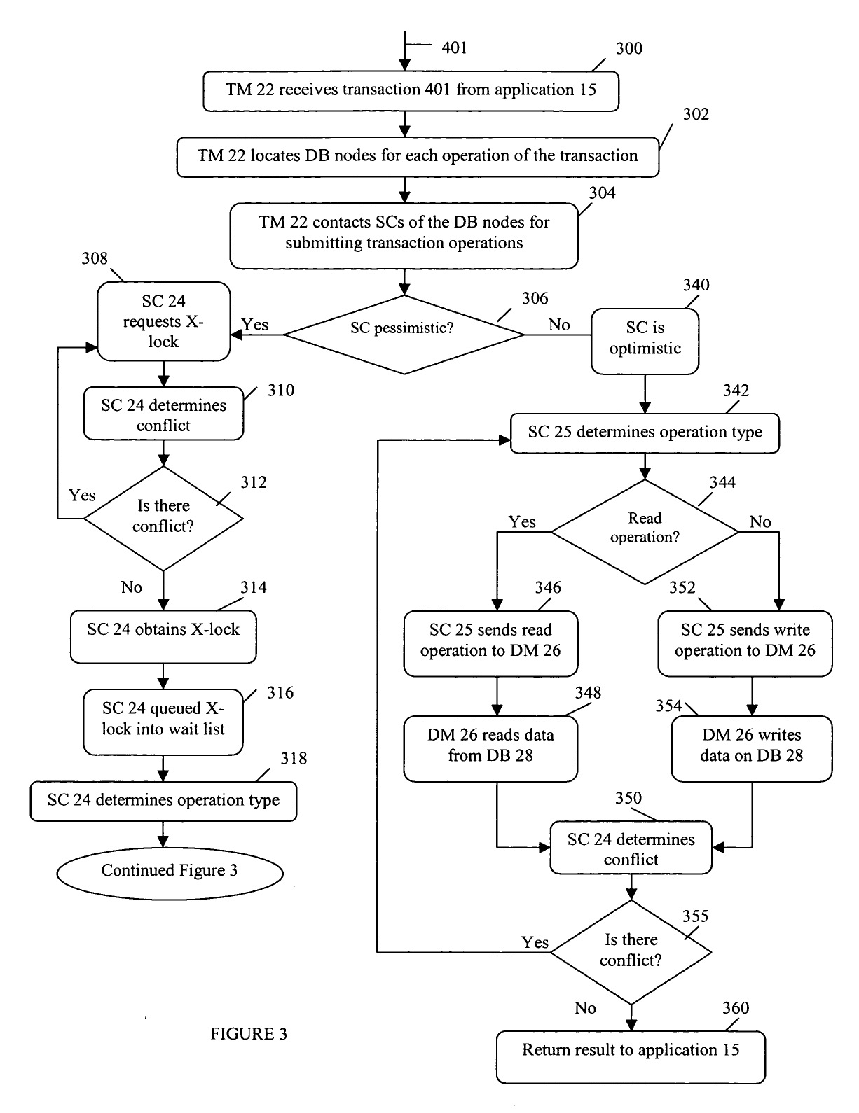

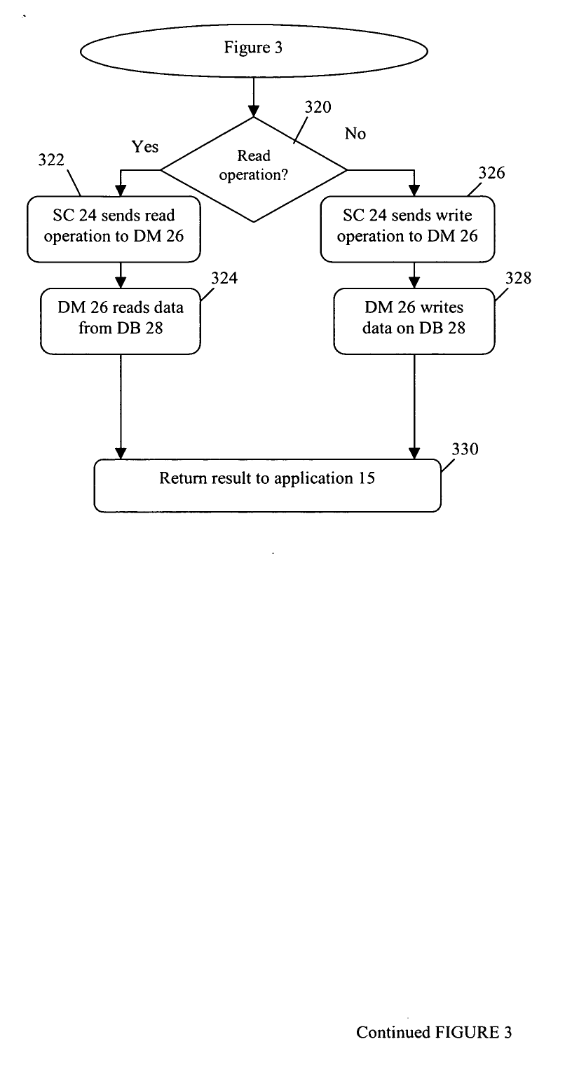

Reference is now made to FIG. 3, which depicts a flow chart of a method for managing the distributed database 21 in accordance to the invention. At step 300, the TM 22 receives a transaction 401 from a service application 15. The TM 22 subdivides the transaction 401 in operations 402, 403 and 404 (step 301). The TM 22 further identifies the DB nodes, which may have stored the data needed by the application 15. The operation may be sent to different type of SCs. An operation is performed differently depending on the type of receiving scheduler: pessimistic or optimistic. After identifying the appropriate DB nodes 28 for each operation (step 304), the TM 22 sends to the SC 24, 34 and 25 the operations 402, 403 and 404 to the SC 24, 34 and 25 respectively in order to be processed by the receiving SCs.

If at step 306, the SC is a pessimistic SC as shown for operation 402, the SC 24 sends a request read/write (X-lock) to its corresponding TM 12 before accessing the data for consistency preservation (step 308). A write lock grants to a transaction an exclusive right to access a data—any transaction in the distributes database 21 that requests read or write access on the same data has to wait until the lock is released. A read lock grants a right to a transaction to access a data if there is no write lock granted—another transaction can be obtained a read lock to access the same data. Read and write operations are often performed to establish a communication or to update a subscriber data. In order to provide some quality of service, the system response time should not exceed a pre-defined time value.

Following step 306, the SC 24 determines if there is an existing conflict between requests sent by different SC for the same information (step 310). More particularly, a conflict may occur transaction is regarding data requested by another existing transaction requested by another TM 22. If there is a conflict at step 312, the SC 24 sends another request for X-lock (step 308) until it obtains the X-lock (step 314). At step 316, the SC 24 obtains the X-lock, the SC 24 queue X-lock into waiting list until the SC 24 determines the operation type (step 318). At step 320, the SC 24 determines that the operation 402 is a read operation and sends the operation to its associated DM 26 (step 322). Then the DM 26 reads the data from DB 28 (step 324) and returns the result to the application 15 (step 330). However, if at step 320 the SC 24 determines that the operation 402 is a write operation the SC 24 sends a write operation to its associated DM 26 (step 326). Then the DM 26 writes the data to its associated DB node 28 (step 328) and returns the result to the application 15 (step 330). Steps 308 to 330 can be apply to any pessimistic SCs such as SC 24.

However at step 306, the SC may rather be optimistic (step 340). For example, the SC 25 may receive the operation 404 of transaction 401. Therefore, at step 342, the SC 25 determines the operation type. At step 344, the SC 25 determines that the operation 404 is a read operation and sends the operation to its associated DM 26 (step 346). Then the DM 26 reads the data from DB 28 (step 348. However, if at step 320 the SC 25 determines that the operation 404 is a write operation, the SC 25 sends a write operation to its associated DM 26 (step 352). Next, the DM 26 writes the data to its associated DB 28 (step 354). At step 350, the SC 25 determines if there is a conflict. If there is a conflict (step 355), the SC 25 repeats step 342 until there is no conflict. If there is no conflict the result of operation is returned to the application 15 (step 360). Steps 340 to 360 can be apply to any optimistic SC such as SC 25.

The performance of the distributed database is rendered efficient if the access to data that are updated more frequently were controlled by a pure pessimistic algorithm while the accesses that are more often in read only mode were controlled by a pure optimistic algorithm.

The algorithm of the present invention is completely distributed and there is no central or static controller. A network operator dynamically configures a concurrency controller. Transactions received at the database 21 from applications 15 are assigned according to their requirements on the level of consistency or the level of performance. The method of the present invention adds a computation layer only during the configuration and deployment phases and this without impacting the performance of the database.

A requirement for high performance can be met if applications such as applications 15 and the data are distributed together with appropriate concurrency control protocol in the distributed database. A requirement for high availability can be met without relaxing any consistency constraint. Therefore, instead of systematically delaying lock request during the execution of transactions, the method of the present invention follows a fully optimistic protocol on nodes with low probability of conflicts. Since the method integrates a pessimistic algorithm and an optimistic algorithm and thus meet to applications' requirements.

Furthermore, unlike existing hybrid algorithms are a trade-off between an optimistic algorithm and a pessimistic algorithm. However, the method of the present invention integrates a pure optimistic algorithm and a pure pessimistic algorithm in a DDBMS.

It can be understood that some messages and therefore some parameters sent from and to network elements in the communication network 20 are not mentioned nor described for clarity reasons. Consequently, some messages and therefore some parameters sent between network elements in the communication network 20 are omitted for clarity reasons.

Although several preferred embodiments of the method and the Core Network Gateway node of the present invention have been illustrated in the accompanying Drawings and described in the foregoing Detailed Description, it will be understood that the invention is not limited to the embodiments disclosed, but is capable of numerous rearrangements, modifications and substitutions without departing from the invention as set forth and defined by the following claims.

What is claimed is:

1. A method for performing an operation at a distributed database for at least one transaction sent from an application in a communication network, the method comprising the steps of:
receiving at a scheduler the operation related to the at least one transaction from a transaction manager;
if the scheduler is a pessimistic scheduler:
requesting at the pessimistic scheduler a read/write lock from its associated transaction manager;
determining at the pessimistic scheduler if there is a conflict for the operation:
if there is a conflict for the operation, the pessimistic scheduler requests a read/write lock for the transaction until obtaining the read/write lock;
if not, the pessimistic scheduler obtains the read/write lock;
if the scheduler is an optimistic scheduler:
determining at the optimistic scheduler an operation type;
determining at the optimistic scheduler if there is a conflict for the operation; and
if there is a conflict the optimistic scheduler determines an operation type until determining that the operation is not in conflict with an operation of another transaction.

2. The method of claim 1, wherein a step of receiving the transaction at a transaction manager of the distributed database is performed prior the step of receiving at a scheduler the operation related to the at least one transaction from a transaction manager.

3. The method of claim 1, wherein the method further comprises the step of returning the result of the request from a database manager to the application server.

4. The method of claim 1, wherein the step of determining at the pessimistic scheduler if there is a conflict for the operation includes the steps of:
obtaining at the pessimistic scheduler read/write lock for the operation;
queuing at the pessimistic scheduler the read/write lock into a waiting list;
determining at the pessimistic scheduler the operation type;
if the operation is a read operation:
sending from the pessimistic scheduler a read operation to an associated database manager;
reading by the associated database manager data from the associated database node;
if the operation is a write operation:
sending from the pessimistic scheduler a write operation to an associated database manager; and
writing by the associated database manager data on the associated database node.

5. The method of claim 1, wherein the steps of determining at the optimistic scheduler an operation type includes the steps of:
if the operation is a read operation:
sending from the pessimistic scheduler a read operation to an associated database manager;
reading by the associated database manager data from the associated database node; if the operation is a write operation:
sending from the pessimistic scheduler a write operation to a associated database manager; and
writing by the associated database manager data on an associated DB node.

6. A distributed database for performing an operation at a distributed database for at least one transaction in a communication network, the distributed database comprising:
at least one pessimistic scheduler for requesting a read/write lock from its associated transaction manager, determining if there is a conflict for the operation, wherein if there is a conflict for the operation, the pessimistic scheduler requests a read/write lock for the transaction until obtaining the read/write lock and if not, the pessimistic scheduler obtains the read/write lock; and
at least one optimistic scheduler for determining an operation type, determining at the optimistic scheduler if there is a conflict for the operation, wherein if there is a conflict the optimistic scheduler determines an operation type until determining that the operation is not in conflict with an operation of another transaction.

7. The distributed database of claim 6, wherein the distributed database further comprises:
a transaction manager for receiving at least one the transaction sent from an application in a communication network at a transaction manager of the distributed database and sending to a scheduler the operation related to the at least one transaction

8. The distributed database of claim 6, wherein the distributed database further comprises:
at least one database manager associated to an pessimistic scheduler, wherein the at least one database manager receives from the pessimistic scheduler an operation and wherein if the pessimistic scheduler determines the operation it is a read operation, the database manager reads data from an associated database node and if the pessimistic scheduler determines the operation is a write operation, the database manager writes on an associated DB node.

9. The distributed database of claim 6, wherein the distributed database further comprises:
at least one database manager associated to an optimistic scheduler for wherein the at least one database manager receives from the optimistic scheduler an operation and wherein if the optimistic scheduler determines the operation it is a read operation, the database manager reads data from an associated database node and if the optimistic scheduler determines the operation is a write operation, the database manager writes on an associated DB node.
